(19) United States
(12) Patent Application Publication
(10) Pub. No.: US 2003/0157841 A1
(43) Pub. Date: Aug. 21, 2003

(54) Digital signal cross-connect module having tin-plated copper plates

(75) Inventors: Soon Nam Jun, San Leandro, CA (US); Jong Ha Moon, Gwangju (KR)

Correspondence Address: SUGHRUE MION, PLLC, 2100 PENNSYLVANIA AVENUE, N.W., WASHINGTON, DC, 20037, US

(73) Assignee: UNICOM TECHNOLOGIES CO., LTD.

(21) Appl. No.: 10/320,617

(22) Filed: Dec. 17, 2002

(30) Foreign Application Priority Data
Feb. 19, 2002 (KR) 2002-8717

(51) Int. Cl. H01R 4/00

(52) U.S. Cl. 439/638

(57) ABSTRACT

A digital signal cross-connect module with output and input jack systems formed on the front aspects of its housing, the output jack system comprising an output jack, a cross-connect output jack and an output signal monitoring jack, the input jack system comprising an input jack, a cross-connect input jack and an input signal monitoring jack, BNC input and output connectors formed on the rear of the housing, BNC cross-connect input and output connectors formed on another aspect of the rear of the housing and arranged in parallel with the BNC input and output connectors in a staggered relationship, first through fourth shielding cables respectively and electrically connecting the output jack and the BNC output jack, the cross-connect output jack and the BNC cross-connect output connector, the input jack and the BNC input jack, and the cross-connect input jack and the BNC cross-connect input connector.

### FIELD OF THE INVENTION

The present invention relates to a digital signal cross-connect module, and particularly to a digital signal cross-connect module having an improved EMI shielding performance and a reduced cross-talk interference by use of tin-plated copper plates and shielding cables.

### BACKGROUND OF THE INVENTION

A digital signal cross-connect module is installed between multiplex communication systems including digital multiplexers and optical termination equipment to perform a cross connection of signals, for example, DS1, DS2, DS3, DS4, STS-1, STS-3, STM-1, etc., patching, test access, and monitoring. An easy interconnection and maintenance of digital network equipment can be achieved by simply interconnecting the digital signal cross-connect modules via circuit split jumpers to create a network and then connecting the digital network equipment to the network. Once digital network equipment is connected to the digital signal cross-connect module, it is possible to easily and efficiently perform tests, monitor, restore and rearrange circuits of that digital network equipment from then on.

These digital signal cross-connect modules may be classified by their transmission speed. For example, a DSX-1 module, normally connected to channel banks, multiplexers, digital switches or the like, is used in an environment of a transmission speed of T1 (1.544 Mbps) or E1 (2.048 Mbps), and a DSX-3 connected to hub nodes of a central office ordinarily has a transmission speed of T3 (44.736 Mbps).

FIG. 1 shows a conventional digital signal cross-connect module. The digital signal cross-connect module 100 includes a first system and a second system formed on a front panel, a first BNC input and output connectors 110, 109, a second BNC input and output connectors 111, 112 formed on a rear panel, and a printed circuit board (PCB, 108) electrically connecting the systems on the front panel to the BNC connectors on the rear panel.

The first system is provided with a pair of output jacks 104, 103 and an output monitoring jack 102 for monitoring signal output from the pair of output jacks 104, 103, and the second system is provided with a pair of input jacks 105, 106 and an input monitoring jack 107 for monitoring signal input to the pair of input jacks 105, 106.

Electrical connections between the output jack 104 of the first system and the first BNC output connector 109, the output jack 103 and the second BNC output connector 111, the input jack 105 and the first BNC input connector 110, and the input jack 106 and the second BNC input connector 112, are all achieved by the separate printed circuit board 108 in module 100 of this conventional device.

Problems associated with using a printed circuit board in electrically connecting the jacks to the BNC connectors, is that it may degrade an EMI shielding performance and increase cross-talk interference, thereby resulting in deteriorated communication quality.

### SUMMARY OF THE INVENTION

It is, therefore, an object of the present invention to provide a digital signal cross-connect module having an enhanced EMI shielding performance and improved cross-talk characteristics.

The object and other objects, which will become apparent to those skilled in the art, are accomplished with a digital signal cross-connect module having a housing with an output jack system formed on a first portion of the front aspect of the housing. The output jack system comprises an output jack, a cross-connect output jack and an output monitoring jack for monitoring signals output from the output jack and the cross-connect output jack. The module also has an input jack system formed on a second portion of the front aspect of the housing, and the input jack system further comprises an input jack, a cross-connect input jack and an input monitoring jack for monitoring signals input into the input jack and the cross-connect input jack. In addition, the module has a BNC input connector and a BNC output connector formed on a first portion of a rear aspect of its housing, and a BNC cross-connect input connector and a BNC cross-connect output connector formed on a second portion of the rear aspect of the housing. The BNC cross-connect input connector and the BNC cross-connect output connector are arranged in parallel and in a staggered relationship with the BNC input connector and the BNC output connector. The module also comprises a first shielding cable electrically connecting the output jack to the BNC output jack, a second shielding cable electrically connecting the cross-connect output jack to the BNC cross-connect output connector, a third shielding cable electrically connecting the input jack to the BNC input jack, and a fourth shielding cable electrically connecting the cross-connect input jack to the BNC cross-connect input connector. The inventive module also has a cross-talk prevention means for grounding the first, second, third and fourth shielding cables to the housing. The module may have copper plates for grounding the first through fourth shielding cables to the housing.

In accordance with one aspect of the present invention, the copper plate is plated with tin and has a base and at least one semi-circular receiver of a semi-circular cross-section protruding from the base and accommodating the shielding cable therein.

In accordance with another aspect of the present invention, the digital signal cross-connect module further comprises a plurality of post pairs protruding from a bottom aspect of the housing to secure the first through fourth shielding cables to the housing.

In accordance with yet another aspect of the present invention, the digital signal cross-connect module further comprises an upper guide shoe and a lower guide shoe which have different lengths from each other and which are formed on lateral sides of the housing.

In accordance with another aspect of the present invention, the semi-circular receivers of the tin-plated copper plate protrude from the base, alternately upward and downward along the lengthwise direction of the tin-plated copper plate.

### BRIEF DESCRIPTION OF DRAWINGS

The above and other objects and features of the present invention will become more apparent from the following description of the preferred embodiments given in conjunction with the accompanying drawings.

FIG. 1 illustrates a prior art digital signal cross-connect module.

FIG. 2 is a perspective view of the digital signal cross-connect module in accordance with a preferred embodiment of the present invention.

FIG. 3 presents a perspective view into the interior of the housing assembly of the digital signal cross-connect module shown in FIG. 2.

FIG. 4 is an elevated front view showing a partially cut-away portion of the digital signal cross-connect module in accordance with the preferred embodiment of the present invention.

FIG. 5a is a side elevational view of the front aspects of the digital signal cross-connect module shown in FIG. 4.

FIG. 5b is a side elevational view of the rear aspect of the digital signal cross-connect module shown in FIG. 4.

FIG. 5c is a top planar view of the digital signal cross-connect module shown in FIG. 4.

FIG. 5d is a bottom view of the digital signal cross-connect module shown in FIG. 4.

FIGS. 6a and 6b show a front elevational view and a side elevational view, respectively, of a first copper plate of the digital signal cross-connect module shown in FIG. 4.

FIG. 6c is a top planar view of a second copper plate used in the present invention.

FIG. 7a is a side elevational view of the digital signal cross-connect module in accordance with another embodiment of the present invention.

FIG. 7b is a front elevational view of the embodiment shown in FIG. 7a.

FIG. 8 is a circuit diagram for the digital signal cross-connect module in accordance with the preferred embodiment shown in FIG. 4 and the other embodiment of FIG. 7 of the present invention.

FIG. 9 is a sectional view of a coaxial cable employed as the shielding cable in the present inventive digital signal cross-connect module.

FIG. 10 provides a schematics for a chassis rail formed on a chassis.

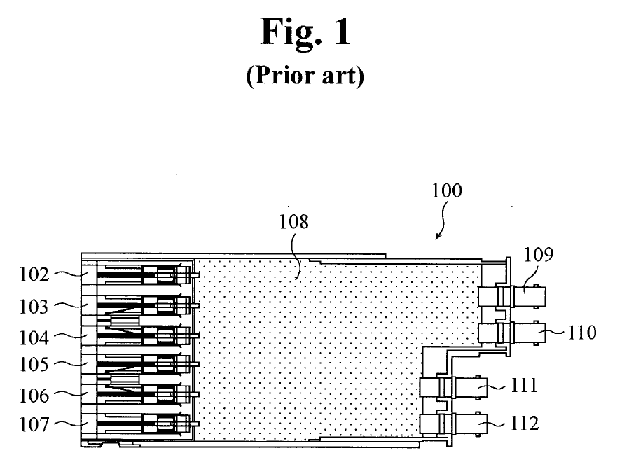

### DETAILED DESCRIPTION OF THE PRESENT INVENTION

A preferred embodiment of the present invention will now be described with reference to the accompanying drawings.

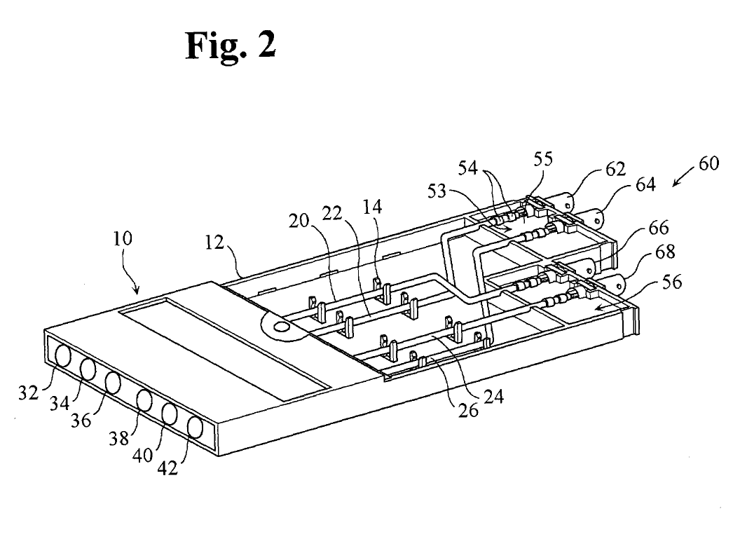

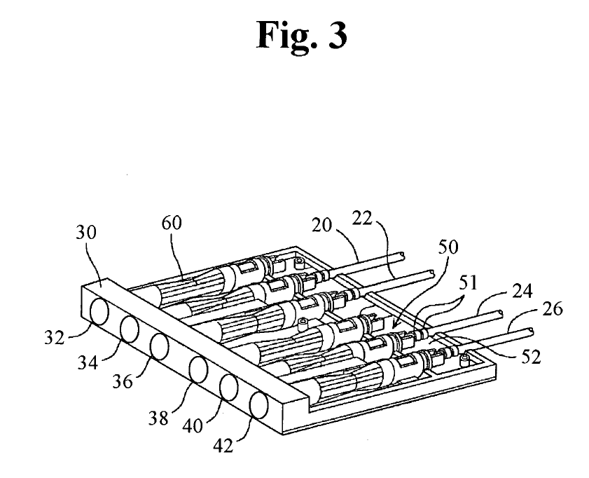

As shown in FIGS. 2 and 3, a digital signal cross-connect module 10 in accordance with a preferred embodiment of the present invention includes a case 12 made of plastic made, for example, by an injection molding process, a metal housing 30 positioned on a frontal portion of the case 12 and formed, for example, through a die-casting process, an output jack system 32, 34, 36 and an input jack system 38, 40, 42 which are installed on the housing 30, four BNC connectors 60 positioned on a rear portion of the case 12, and shielding cables 20, 22, 24, 26 for connecting the BNC connectors 60 to the output jack system 32, 34, 36 and the input jack system 38, 40, 42.

As shown in FIG. 3, the output jack system includes an output jack 34, a cross-connect output jack 36 and an output monitoring jack 32 for monitoring signal output from the output jack 34 and the cross-connect output jack 36. The input jack system includes an input jack 40, a cross-connect input jack 42 and an input monitoring jack 38 for monitoring signal input to the input jack 40 and the cross-connect input jack 42. It is preferable that the output jack system and the input jack system are installed in the housing in a side by side arrangement. Indicia (not shown) for identifying the jacks can be represented adjacent the jacks.

In the preferred embodiment, each of the jacks is a WECO type connector and the output jack 34, the cross-connect output jack 36, the input jack 40 and the cross-connect input jack 42 are connected to one ends of the shielding cables 20, 22, 24, 26, respectively.

Returning to FIG. 2, a BNC cross-connect output connector 62, a BNC cross-connect input connector 64, a BNC output connector 66 and a BNC input connector 68 are mounted on the rear portion of the case 12. The BNC connectors 60 are connected to the other ends of the shielding cables 20, 22, 24, 26, respectively, which are connected to the output jack 34, the cross-connect output jack 36, the input jack 40 and the cross-connect input jack 42, respectively, at their one ends.

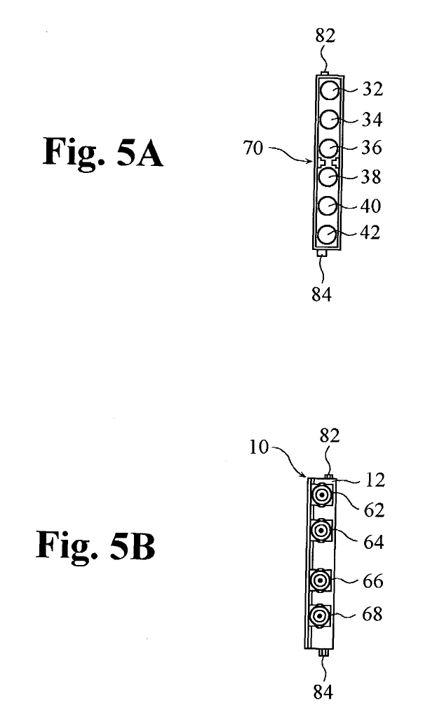

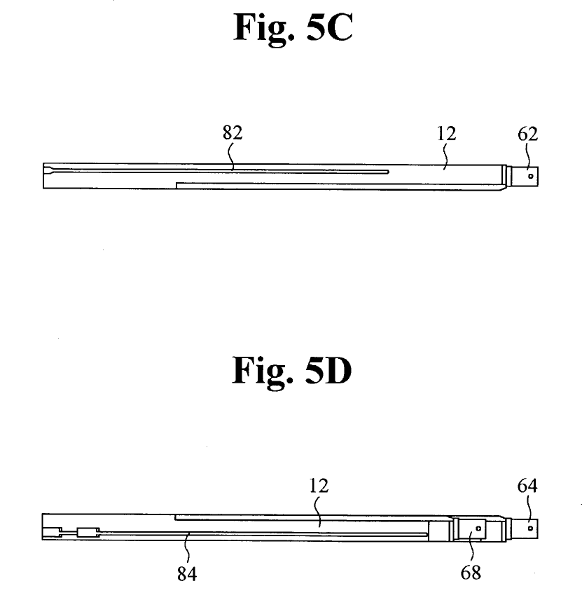

In accordance with the preferred embodiment of the present invention, a rear panel of the module 10 has a stepped arrangement, whereby the ends of the BNC cross-connect output connector 62 and the BNC cross-connect input connector 64 arranged together parallel to each other, extend further and beyond the length of the BNC output connector 66 and the BNC input connector 68. In other words, the ends of the BNC cross-connect output connector 62 and BNC cross-connect input connector 64 are staggered with respect to the ends of the BNC output connector 66 and BNC input connector 68, in a step-wise fashion. Further, as shown in FIG. 5b, the BNC connectors 60 are arranged biased in position toward an upper side of the module 10.

Referring to FIGS. 2 and 3, the shielding cable 20 connects the output jack 34 to the BNC output connector 66, the shielding cable 22 connects the cross-connect output jack 36 to the BNC cross-connect output connector 62, the shielding cable 24 connects the input jack 40 to the BNC input connector 68, and the shielding cable 26 connects the cross-connect input jack 42 to the BNC cross-connect input connector 64. The use of the shielding cables in the electrical connection between the jacks and connectors not only reduces the interference by EMI, but also considerably improves the cross-talk characteristics of the module 10.

In the preferred embodiment, a coaxial cable, which will be described in further detail below, is used for the shielding cable. The use of the coaxial cable provides enhanced workability in grounding the shielding cables to the metal housing 30 via a first through a third copper plates 50, 53, 56 which are described in detail hereinbelow.

In order to enhance the cross-talk characteristics, the inventive digital signal cross-connect module 10 employs a plurality of copper plates including the first copper plate 50, the second copper plate 53 and the third copper plate 56. For purposes of preventing copper from oxidation or corrosion, the copper plates 50, 53, 56 are plated with tin. A proper plating thickness can be determined by selecting a proper plating method from the various plating methods, e.g., hot tinning, electro tinning, etc.

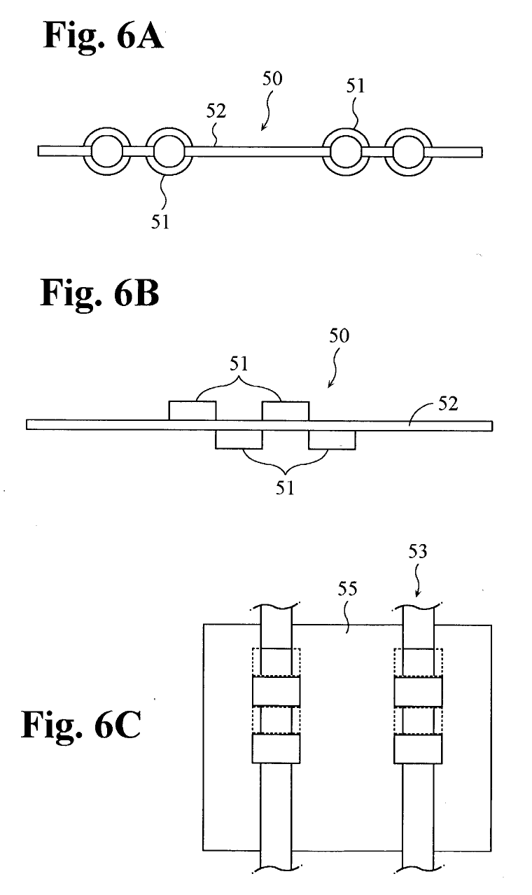

As shown in FIGS. 3 and 6a, the first copper plate 50 includes a base 52 and a plurality of semi-circular receiver 51. The semi-circular receiver 51 having a semi-circular cross section protrudes from a principal surface of the base 52. The semi-circular receivers 51 receive therein, ends of the shielding cables 20, 22, 24, 26 connected to the first and second jack systems to mount and ground them to the housing 30. As depicted in FIG. 6a showing a frontal view of the copper plate 50, the semi-circular receiver 51 protrudes from the base 52 of the first copper plate 50 in both downward and upward directions. Further, as illustrated in FIG. 6b showing a side view of the copper plate 50, it is preferable that the upper semi-circular receiver 51 be in an offset relationship in position with the lower semi-circular receiver 51 along a lengthwise direction of the copper plate 50. In other words, the semi-circular receivers 51 alternately protrude from the base 52 upwardly and downwardly along the lengthwise direction of the copper plate 50.

The semi-circular receivers 51 of the first copper plate 50 constructed in this manner functions to secure and ground the ends of the shielding cables closer to the jacks to the housing 30 in a following manner.

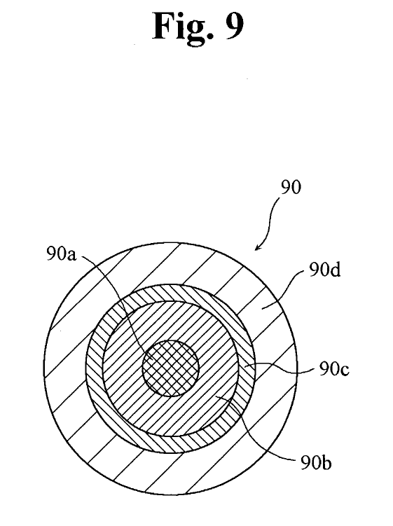

As shown in FIG. 9, the coaxial cable 90 employed as the shielding cable in the preferred embodiment includes a central conductor 90a, an insulation layer 90b, an outer conductor 90c and a sheath 90d. Before the shielding cables 20, 22, 24, 26 of the coaxial cable 90 are inserted into the semi-circular receivers 51, the sheaths 90d of the coaxial cables 90 have to be removed to disclose the outer conductors 90c. When inserted into the semi-circular receiver 51, the outer conductor 90d comes into electrical contact with the semi-circular receiver 5l. Then, the first copper plate 5l accommodating the shielding cables 20, 22, 24, 26 is mounted on a predetermined position in the metal housing 30 to be electrically contacted to the housing 30, making a grounding channel from the shielding cables to the housing 30.

Some commercially-available coaxial cables do not have a sheath with the outer conductor exposed to outside. This type of coaxial cable may be immediately inserted into the semi-circular receiver 51 without the removing process of the sheath.

As shown in FIG. 2, the second copper plate 53 serves to secure the ends of the shielding cables 22, 26 closer to the BNC cross-connect output/input connectors 62, 64 to the case 12. As shown in FIG. 6c, the second copper plate 53 includes a base 55, and a plurality of semi-circular receivers 54 each having a semi-circular cross-section. Similar to the configuration of the first copper plate 50, the semi-circular receivers 54 also protrude from the base 55 in both upward and downward directions and the upper semi-circular receiver and the lower semi-circular receiver protrude from the base 55 alternately along a lengthwise direction of the second copper plate 53.

Referring to FIG. 2, the third copper plate 56 has the same configuration as that of the second copper plate 53 and serves to secure the ends of the shielding cables 20, 24 closer to the BNC output/input connectors 66, 68 to the case 12.

The second copper plate 53 and the third copper plate 56 are, preferably electrically connected to the outer conductors 90c of the shielding cables at their semi-circular receivers 54.

The first through the third copper plates 50, 53, 56 constructed in this manner can reduce any interference or cross-talk that may be induced in the shielding cables 20, 22, 24, 26, by grounding the shielding cables to the housing 30.

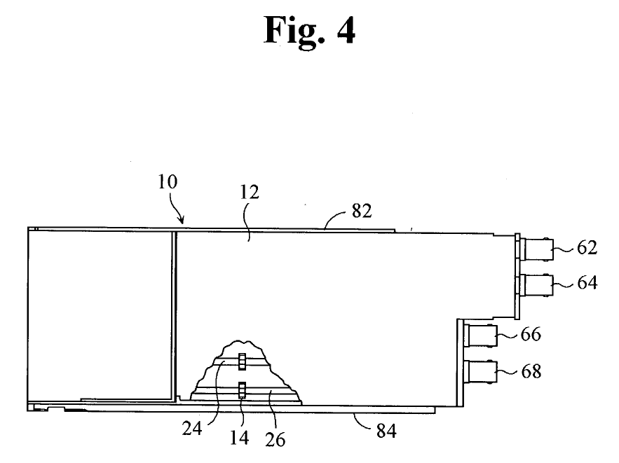

Central portions of the shielding cables 22, 24, 26, 28 secured to the housing 30 and the case 12 at both ends via the first through the third copper plates 50, 53, 56 are secured to the case 12 by means of a plurality of post pairs 14 protruding from a bottom of a case 12, as shown in FIGS. 2 and 4. These post pairs 14 function to suppress the induction of the electromagnetic wave or the like that may occur when the position of the shielding cables are changed with respect to one another within the module 10.

Referring to FIGS. 4 and 5a through 5d, the inventive digital signal cross-connect module 10 is further provided with an upper guide shoe and a lower guide shoe 82, 84 that have different lengths from each other and are formed at both lateral sides of the case 12, respectively. When the module 10 is inserted into or extracted out of a slot of a chassis (not shown), the guide shoes 82, 84 are engaged into chassis rails 92, respectively, which are formed on the chassis.

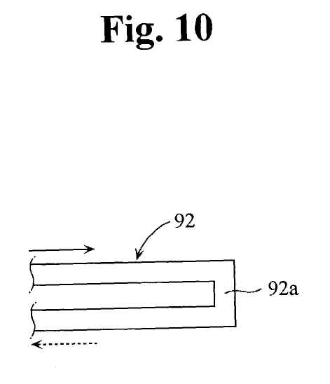

As shown in FIG. 10, the chassis rail 92 has a length substantially equal to that of the upper guide shoe 82 or the lower guide shoe 84 that it corresponds to and has an end wall 92a for stopping the advancement of the corresponding shoe 82 or 84. The guide shoes 82 and 84 advances in a direction indicated with a solid arrow, being engaged into the chassis rail 92, when the module 10 is equipped into the chassis. Further, the guide shoes 82, 84 move in a direction indicated with a dotted arrow, when the module 10 is removed from the chassis. Accordingly, when inserted into the chassis upside down, the module 10 cannot reach a desired position within the chassis. With this configuration, the module 10 can be exactly seated on the chassis and smoothly removed out of the chassis. In the preferred embodiment, as shown in FIG. 4, the lower guide shoe 84 is longer than the upper guide shoe 82.

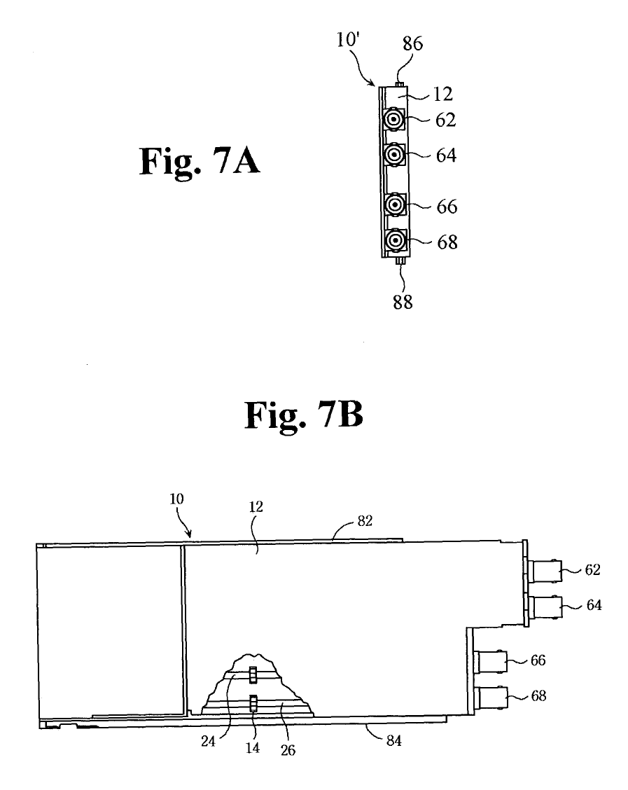

FIGS. 7a and 7b show a modification of the digital signal cross-connect module in accordance with the preferred embodiment of the present invention. The module 10′ of the modification is a mate module to the module 10 that is used in the chassis together with the module 10. A comparison of FIGS. 5b and 7a shows that BNC connectors 62, 64, 66, 68 of the module 10′ shown in FIG. 7a are positioned eccentric to a lower side of the module 10′, while the BNC connectors 62, 64, 66, 68 of the module 10 shown in FIG. 5b are biased to the upper side of the module 10, with the same separation between the BNC connectors. To be more specific, for example, a height of the BNC cross-connect input connector 64 of the module 10 from the lower side of the module 10 corresponds to a position between the BNC cross-connect output connector 62 and the BNC cross-connect input connector 64 of the module 10′. Accordingly, when the module 10′ and the module 10 are alternately arranged in the chassis along the width of the chassis, the positions of the BNC connectors of the modules 10′ are misaligned with the positions of the corresponding BNC connectors of the modules 10. In other words, positions of the BNC connectors of the plurality of modules 10 and 10′ arranged in the chassis, make a zigzag along the width of the chassis. This allows the operator to conveniently access and work on the BNC connectors, e.g., plugging/unplugging other connectors into/from the BNC connectors.

Further, as can be seen from a comparison between FIG. 4 and FIG. 7b, upper guide shoe 86 is shorter than lower guide shoe 88 in the module 10′, unlike module 10. This prevents the module 10′ from being wrongly inserted into the slot of the chassis for the module 10.

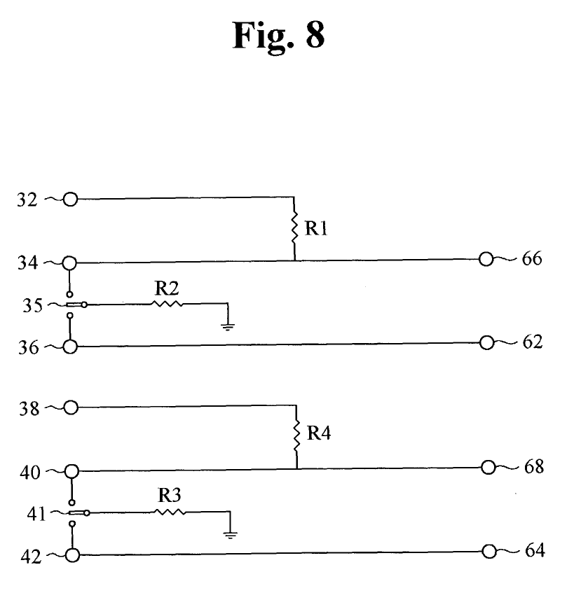

Referring to the circuit diagram shown in FIG. 8, it can be seen that the output jack 34 is electrically connected to the BNC output connector 66; and the cross-connect output jack 36 is electrically connected to the BNC cross-connect output connector 62. The output monitoring jack 32 is electrically connected to the output jack system via a monitoring resistor R1 diverged from a line connecting the output jack 34 and the BNC output connector 66.

Further, it can be understood that the input jack 40 is electrically connected to the BNC input connector 68, and the cross-connect input jack 42 is electrically connected to the BNC cross-connect input connector 64. The input monitoring jack 38 is electrically connected to the input jack system via a monitoring resistor R4 diverged from a line connecting the input jack 40 and the BNC input connector 68.

In order to monitor the input/output signals without influence on the signal transmission, resistances of the monitoring resistors R1, R4 can be determined such that signal levels of a line connecting the output monitoring jack 32 to the monitoring resistor R1 and a line connecting the input monitoring jack 38 to the monitoring resistor R4 are lower than the signal levels output through the BNC output/input connectors 66, 68.

A switch 35 shown in FIG. 8 is switched to connect a resistor R2 to the cross-connect output jack 36, when the output jack 34 is plugged with other connector. As a result, the line of the cross-connect output jack 36 is grounded. Further, a switch 41 is switched to connect a resistor R3 to the cross-connect input jack 42, when the input jack 40 is plugged with other connector. As a result, the line of the cross-connect input jack 42 is grounded.

The inventive digital signal cross-connect module has an enhanced EMI shielding performance and a cross-talk characteristics improved by 75dB by using the tin-plated copper plates and the shielding cables. Further, the shielding cable allows a more stable signal transmission. Further, since the semi-circular receivers of the copper plate securing the shielding cable have the configuration where they alternately protrude upwardly or downwardly from the base along the length of the copper plate, only minimized stress occurs at the shielding cable. This reduces noise induction due to deformation of the shielding cable.

While the present invention has been shown and described with respect to particular embodiments, it will be apparent to those skilled in the art that many changes and modifications may be made without departing from the spirit and scope of the invention as defined in the appended claims.

What is claimed is:

1. A digital signal cross-connect module, comprising:
a housing;
an output jack system formed on a first portion of the front aspect of said housing, the output jack system further comprising an output jack, a cross-connect output jack and an output monitoring jack for monitoring signals output from the output jack and the cross-connect output jack;
an input jack system formed on a second portion of said front aspect of said housing, the input jack system further comprising an input jack, a cross-connect input jack and an input monitoring jack for monitoring signals input into the input jack and the cross-connect input jack;
a BNC input connector and a BNC output connector formed on a first portion of a rear aspect of said housing;
a BNC cross-connect input connector and a BNC cross-connect output connector formed on a second portion of said rear aspect of said housing, the BNC cross-connect input connector and the BNC cross-connect output connector arranged in parallel and in a staggered relationship with said BNC input connector and said BNC output connector;
a first shielding cable electrically connecting said output jack and said BNC output jack;
a second shielding cable electrically connecting said cross-connect output jack and said BNC cross-connect output connector;
a third shielding cable electrically connecting said input jack and said BNC input jack;
a fourth shielding cable electrically connecting said cross-connect input jack and said BNC cross-connect input connector; and
a cross-talk prevention means for grounding said first, said second, said third and said fourth shielding cables to said housing.

2. The digital signal cross-connect module of claim 1, wherein said cross-talk prevention means is a tin-plated copper plate having a base and at least one receiver having a semi-circular cross-section, the receiver protruding from the base and accommodating said shielding cable therein.

3. The digital signal cross-connect module of claim 1, further comprising a plurality of post pairs protruding from a bottom of said housing to secure said first, said second, said third and said fourth shielding cables to said housing.

4. The digital signal cross-connect module of claim 1, further comprising an upper guide shoe of a first length and a lower guide shoe of a second length, the first length being different from the second length, and each formed on respective lateral sides of said housing.

5. The digital signal cross-connect module of claim 2, wherein said receiver of said tin-plated copper plate protrudes from said base alternately upward and downward along a lengthwise direction of the tin-plated copper plate.

6. The digital signal cross-connect module of claim 2, further comprising a plurality of post pairs protruding from a bottom of said housing to secure said first, said second, said third and said fourth shielding cables to said housing.
